(19) United States
(12) Patent Application Publication
(10) Pub. No.: US 2025/0165381 A1
(43) Pub. Date: May 22, 2025

(54) DIFFERENCE CHECKER OF SOFTWARE APPLICATION INSTANCE SCOPES

(71) Applicant: Nuvolo Technologies Corporation, Paramus, NJ (US)

(72) Inventors: Viktor Dakov, Sofia (BG); Nikolay Neykov, Sofia (BG); Tsveti Stoyanov, Sofia (BG)

(21) Appl. No.: 18/511,319

(22) Filed: Nov. 16, 2023

(51) Int. Cl. G06F 11/36

(52) U.S. Cl. CPC G06F 11/3692; G06F 11/3698

(57) ABSTRACT

A method, a system, and computer program product comprising retrieving a second version of the cloud-based software application hosted by the cloud-based computing system, the second version of the cloud-based software application corresponding to a second instance of the version of the cloud-based software application, comparing the first version of the cloud-based software application to the second version of the cloud-based software application, generating based on the comparison, by the one or more processors, a result comprising differences between the first version of the cloud-based software application and the second version of the cloud-based software application, and outputting the result on a display that is communicatively coupled to the one or more processors.

### TECHNICAL FIELD

The subject matter described herein relates generally to software error corrections and more specifically to automatic implementation of solutions for software errors based on differences in instance scopes.

### BACKGROUND

As distributed applications have grown more complex in recent years, and the scale of computing loads has grown, many distributed software applications have been designed (or redesigned) to provide more, and more diverse, services. Functionalities that were previously implemented within single threads on individual computing devices (e.g., as executable sub-routines) are currently customized into distinct services that are deployed via a network interface, as cloud-based software applications, rather than by function calls within a corresponding thread. The changes in development, testing, and deployment processes implemented for diverse customization of cloud-based software applications can introduce a large variety of errors that can affect the service stability.

### SUMMARY

Systems, methods, and articles of manufacture, including computer program products, are provided for determining differences in instance scopes to assist with solving software application errors.

In one aspect, a computer-implemented method is described. The method comprises receiving, by one or more processors, data of an error included in a first version of a cloud-based software application hosted by a cloud-based computing system, the first version of the cloud-based software application corresponding to a first instance of a version of the cloud-based software application, retrieving, by the one or more processors, a second version of the cloud-based software application hosted by the cloud-based computing system, the version of the cloud-based software application corresponding to a second instance of the version of the cloud-based software application, comparing, by the one or more processors, the first version of the cloud-based software application to the second version of the cloud-based software application, generating based on the comparing, by the one or more processors, a result comprising differences between the first version of the cloud-based software application and the second version of the cloud-based software application, and outputting the result on a display that is communicatively coupled to the one or more processors.

In some variations, one or more features disclosed herein including the following features can optionally be included in any feasible combination. In aspects, the computer-implemented method further comprises enabling, by the one or more processors, a correction of the error based on the result comprising the differences between the first version of the cloud-based software application and the second version of the cloud-based software application. In aspects, the computer implemented method further comprises ranking a plurality of solutions to correct the error, determining that parameters of a first solution of the plurality of solutions are below a threshold, and automatically implementing the first solution of the plurality of solutions to correct the error. In aspects, the correction of the error comprises a modification of an object of the cloud-based software application and the object comprises an access control list dependent object (ACL DO) comprising an access control list, the access control list being used as part of an access control check to confirm whether a tenant is allowed to execute an operation.

In aspects, the access control list dependent object is accessed via an access path within the object that is specified by the object and the access control check comprises a verification of an object type corresponding to the object specified and of on an access group. In aspects, the access control list specifies which nodes of the object specified and of on an access group are subject to instance control, the access control list further specifies which access groups can perform operations on each node of an object instance. In aspects, the access control list further specifies operations enabled to be performed on each of the nodes of the object instance by particular access groups. In aspects, the access control list specifies temporal access limitations for one or more nodes of the object instance. In aspects, the first version of the cloud-based software application comprises one or more customizations associated with the cloud-based computing system. In aspects, the data of the error is included as part of a digital error log, the error is associated with a software identifier and a device identifier, and the software identifier is representative of an object of the first version of the cloud-based software application that failed to deploy and the device identifier is representative of an object instance associated with the error.

In another aspect, there is provided a system. The system can include at least one data processor and at least one memory. The at least one memory can store instructions that cause operations when executed by the at least one data processor. The operations can include receiving, by the at least one data processor, data of an error included in a first version of a cloud-based software application hosted by a cloud-based computing system, the first version of the cloud-based software application corresponding to a first instance of a version of the cloud-based software application, retrieving, by the at least one data processor, a second version of the cloud-based software application hosted by the cloud-based computing system, the second version of the cloud-based software application corresponding to a second instance of the version of the cloud-based software application, comparing, by the at least one processor, the first version of the cloud-based software application to the second version of the cloud-based software application, and generating based on the comparing, by the at least one data processor, a result comprising differences between the first version of the cloud-based software application and the second version of the cloud-based software application, and outputting the result on a display that is communicatively coupled to the at least one data processor.

In yet another embodiment, there is provided a non-transitory computer readable storage media comprising programming code, which when executed by a least one data processor, causes operations comprising: receiving data of an error included in a first version of a cloud-based software application hosted by a cloud-based computing system, the first version of the cloud-based software application corresponding to a first instance of a version of the cloud-based software application, retrieving a second version of the cloud-based software application hosted by the cloud-based computing system, the second version of the cloud-based software application corresponding to a second instance of the version of the cloud-based software application, comparing the first version of the cloud-based software application to the second version of the cloud-based software application, generating, based on the comparing, by the at least one data processor, a result comprising differences between the first version of the cloud-based software application and the second version of the cloud-based software application, and outputting the result on a display that is communicatively coupled to the at least one data processor.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features.

Similarly, computer systems are also described that can include one or more processors and one or more memories coupled to the one or more processors. A memory, which can include a non-transitory computer-readable or machine-readable storage medium, can include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a diagram of an example system, in accordance with some example implementations;

FIG. 2A depicts an example conceptual architecture, in accordance with some example implementations;

FIG. 2B depicts another example conceptual architecture, in accordance with some example implementations;

FIG. 3 depicts a flowchart illustrating an example process, in accordance with some example implementations; and

FIG. 4 depicts a block diagram illustrating a computing system, in accordance with some example implementations.

When practical, similar reference numbers denote similar structures, features, or elements.

### DETAILED DESCRIPTION

Implementations of the present disclosure are generally directed to software error corrections and more specifically to automatic implementation of solutions for software errors based on differences in instance scopes. When software application errors occur in a computing system an error log can be generated. The error log can include a report of software application errors, such as a failure to deploy a software product at a computing system, such as from a development system to a testing system, or from a testing system to a deployment system including multiple computing components. The overall setup of computing system can be very complex and can depend on many components. Some computing components can have a fixed version and other computing components can vary. The variable computing components are called “moving parts.” In some environments, especially in cloud computing environments the “moving parts” can have a significant effect on the stability, leading to software application errors.

Some software application errors can appear in an instance of the software application, while missing from a previously verified instance of the software application. An instance of the software application can be defined based on object instances. Objects can be described by a data model, an internal process model, and one or more typed service interfaces, and can be a core structuring element of applications that are centrally defined by a developer as a part of an overall governance process. Object data structures encapsulate semantically related functionality and structure. An object can include a hierarchy of semantically related nodes which represent data as attributes. In addition, an object can be an independently viable entity with identifiable instances as well as bundle functions and data, both of which may be accessible from outside of the object. Access control lists (ACL) can be used to selectively provide access to object data structures. A comparison of multiple object instances corresponding to different time points, can enable identification of identical or similar issues, such as missing objects, different objects, and ACL changes. Current software application errors can be matched with past software application errors based on the pattern of the software application errors. The match between current and past software application instances can be used to identify solutions for troubleshooting the current software application errors in order to successfully complete software deployment, eliminating a transitional error ticketing system for reviewing and solving software application errors.

Traditionally, all software application errors, including repeated software application errors and including software application errors with similar issues, are transmitted to people assigned to solve them. In some cases, troubleshooting software application errors could require significant efforts to solve. Traditional identification and implementation of solutions that correctly resolve the root cause can take extensive time periods (e.g., weeks or months) that delay completion of software deployment or access to customized services. Troubleshooting of transient software application errors associated with variable computing components can require new solutions, as a difference to troubleshooting repeated software application errors. Automatic processing of software application errors combined with automatic implementation of solutions based on error patterns derived from software application instance changes can increase troubleshooting efficiency by minimizing the time needed to identify and implement solutions to successfully complete software deployment and provide access to error free customized services.

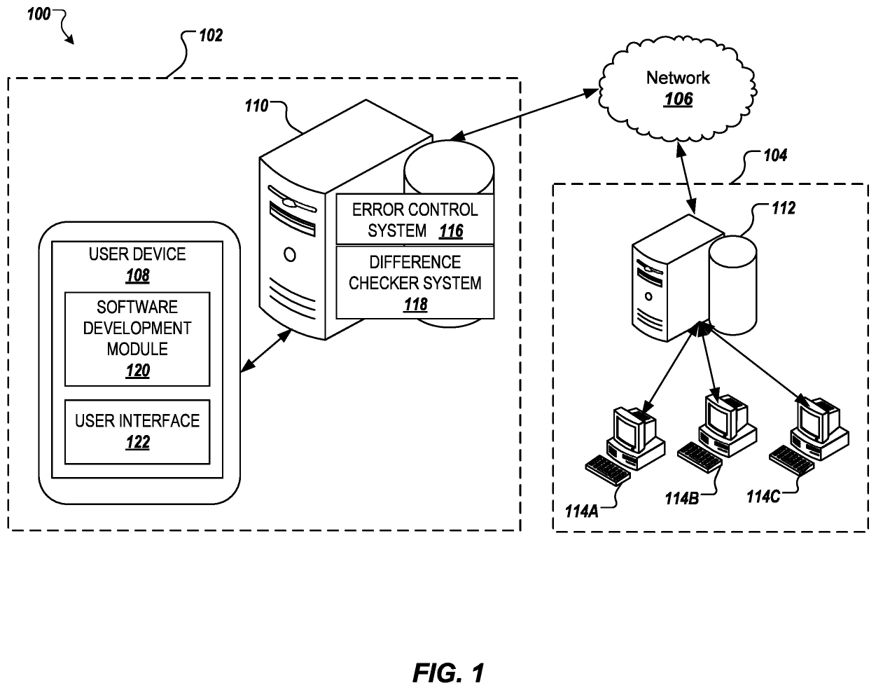

FIG. 1 depicts a diagram of an example system 100, for addressing software application errors, in accordance with some example implementations. The example system 100 can include a development system 102 (e.g., a development and testing system), a deployment system 104 (e.g., a deployment and production system), and a network 106. The development system 102 includes a user device 108 and a first server system 110. The deployment system 104 includes a second server system 112 and multiple computing devices 114A, 114B, 114C. The example system 100 can include a plurality of software development, testing, customization, and deployment trackers, which can be deployed across different remote systems, such as the development system 102 and the deployment system 104.

In the example of FIG. 1, the first and second server systems 110, 112 are intended to represent various forms of servers including, but not limited to a web server, an application server, a proxy server, a network server, and/or a server pool. The first and second server systems 110, 112 can accept requests for services of applications that enable customer (e.g., tenant) specific customization and provide such services to any number of user devices over the network 106. The first server system 110 can include a customizing engine, a database, a development system, a test system, and a production system. The (external) database can be include a multi-customer (multi-tenant) database architecture (e.g., multi-customer database containers (MDC)), such that each customer of the second server system 112 (using respective computing devices 114A, 114B, 114C) can customize respective tables stored by the database and can be served by separate instances of the first and second server systems 110, 112. In some implementations, the database can include an on-premise database system (e.g., system databases, tenant databases, etc.), servers (e.g., name server(s), index server(s), script server(s), etc.). The database can store multiple tables that can be accessible (e.g., via queries, procedure calls, etc.) by the customizing engine, in response to a customization request received from one or more of the computing devices 114A, 114B, 114C and by cloud-based software applications. The external database can include a runtime database that holds most recent database tables and respective branch numbers to enable customization of application settings defining application instances, according to tenant preferences.

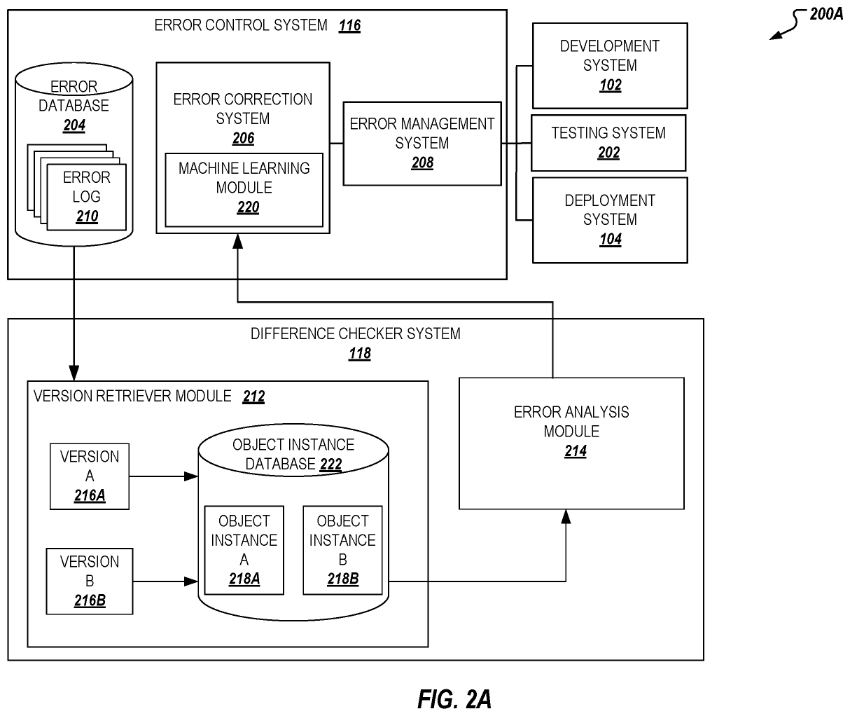

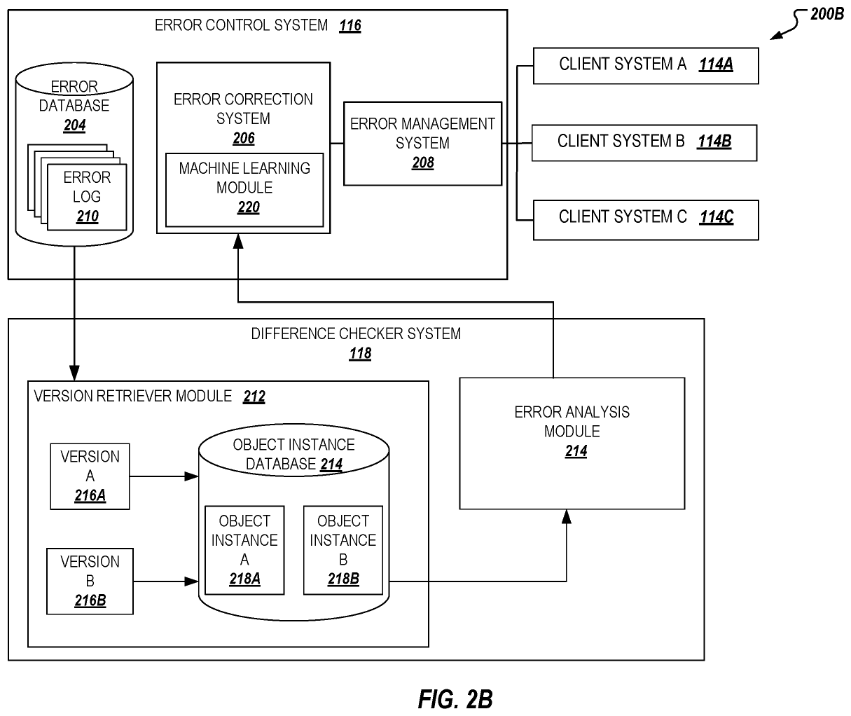

In general, the first and second server systems 110, 112 accept requests for application services and provide such services to any number of user devices (e.g., the user device 108 and computing devices 114A, 114B, 114C) over the network 106. In some implementations, the first server system 110 can include a development tracker of development stacks of software applications in development environments and the second server system 112 can include a deployment tracker of deployed software applications in a production environment and customized software applications deployed in upstream environments. One or more of the first and second server systems 110, 112 can include an error control system 116 and a difference checker system 118. The error control system 116 includes at least one server and at least one data store configured to store data associated with past software application errors including deployment error patterns, as described in detail with reference to FIGS. 2A and 2B. The difference checker system 118 can perform a comparison of multiple instances of the software application to identify changes between the instances associated with the detected errors, as described in detail with reference to FIGS. 2A and 2B.

In accordance with implementations of the present disclosure, the first server system 110 can include a development management system configured to manage the development of a software product, portions of the software product being developed by the user device 108. The first server system 110 can host a development tracking service (e.g., provided as one or more computer-executable programs executed by one or more computing devices) configured to track software development executed at the user device 108. The development tracker included in the first server system 110 can be connected to the user device 108, which can be associated with a software developer. In the depicted example, the user device 108 includes a software development module 120 and a user interface 122. The software development module 120 can be configured to enable creation and modification of software products. The user interface 122 can enable an entry of a user input to initiate deployment of the new or modified software product and a display of deployment results including deployment logs.

The software development module 120 can use a software stack or development stack (e.g., a combination of programming languages, frameworks, libraries, tools, and technologies) to develop the software product (including one or more objects) to be deployed by the deployment system 104. The development tracking service of the first server system 110 can use as input data provided by the user device 108. The first server system 110 can process the input data through a software development and deployment service to generate result data (e.g., a deployment package for completed software products) that are stored as instances associated with a particular time point and transmitted to the deployment system 104 to be processed for deployment. For example, the first server system 110 can send the result data to the second server system 112 over the network 106, which can coordinate and track software deployment throughout the deployment environment including the computing devices 114A, 114B, 114C. The second server system 112 can include a deployment management system configured to transmit the software product to one or more computing devices 114A, 114B, 114C. The second server system 112 can track, using a deployment tracker, the deployment of an instance of the software product to the one or more computing devices 114A, 114B, 114C and can detect any occurring errors corresponding to the instance of the (customized) software product. The deployment tracker deployed at the second server system 112 can be connected to each of the computing devices 114A, 114B, 114C to enable retrieval of object instances and ACL instances at a time point when errors were detected. The computing devices 114A, 114B, 114C can be associated with end users.

The user device 108 and/or the computing devices 114A, 114B, 114C can be and/or include any type of processor and memory based device, such as, for example, cellular phones, smart phones, tablet computers, laptop computers, desktop computers, workstations, personal digital assistants (PDA), network appliances, cameras, enhanced general packet radio service (EGPRS) mobile phones, media players, navigation devices, email devices, game consoles, or an appropriate combination of any two or more of these devices or other data processing devices. In some implementations, at least two of the computing devices 114A, 114B, 114C include different computing system configurations, such as different operating systems, different processing capabilities, different hardware components, and/or other differences. As shown in FIG. 1, the user device 108 can be communicatively coupled with the first and second server systems 110, 112 to track software deployment, via the network 106. It should be appreciated that the network 106 can be any wired and/or wireless network including, for example, a public land mobile network (PLMN), a local area network (LAN), a wide area network (WAN), the Internet, a cellular network, a telephone network (e.g., PSTN) or an appropriate combination thereof connecting any number of communication devices, mobile computing devices, fixed computing devices, server systems, and/or the like. The user device 108 and/or the computing devices 114A, 114B, 114C can include any combination of fixed and variable computing components.

In some example implementations, the development tracker of the first server system 110 can interact with the deployment tracker of the second server system 112 in order to coordinate the development and deployment of a software product and to collect errors to be processed by the error control system 116. The software creation and/or update can include one or more features. Furthermore, each software product instance can include one or more changes relative to another (older verified error free) software product instance. A product specification object can include a plurality of feature objects corresponding to the features of a software update that can correspond to a particular software product instance. The feature object can include a plurality of change objects that can correspond to the changes required to implement the feature corresponding to the feature object. The development of the software update can include implementing the features by at least completing the tasks that are required to effect the changes associated with each feature.

According to some example implementations, the development tracker of the first server system 110 and the deployment tracker of the second server system 112 can generate and/or maintain a plurality of hierarchical tracking objects corresponding to the software creation and/or update as well as the features of each software product instance and implemented changes in different software product instances. The development tracker of the first server system 110 can maintain a first plurality of tracking objects and the deployment tracker of the second server system 112 can maintain a second plurality of tracking objects. Each of the development tracker and the deployment tracker can transmit the tracking objects (including patterns of software application errors) to the error control system 116. It should be appreciated that a tracking object can be a running computer process configured to interact with one or more other tracking objects. As used herein, a computer process can be an instance of a computer program that is being executed.

A tracking object at the development tracker of the first server system 110 can interact with a corresponding tracking object at the deployment tracker of the second server system 112 in order to track, for example, the completion of a task required to realize a change associated with a feature of the software creation and/or update to enable successful software deployment at each of the computing devices 114A, 114B, 114C. The second server system 112 can generate a deployment log including software application errors indicating a failure to deploy the software product at one or more of the computing devices 114A, 114B, 114C. The error control system 116 installed in any of the first and second server systems 110, 112 can be configured to extract the software application errors from the deployment log and match the extracted software application errors to past software application errors based on differences, identified by the difference checker system 118, between different software application instances to identify a solution to correct the detected error. Any of the first and second server systems 110, 112 can be configured to implement the solution (e.g., modify the software product and/or a setting of one or more variable or static components of the computing devices 114A, 114B, 114C) to successfully complete the software deployment and provide customized services to each of the computing devices 114A, 114B, 114C.

FIGS. 2A and 2B depict examples of conceptual architectures 200A and 200B that are configured for an interaction between system components to automatically address software application errors, in accordance with some example implementations. The example conceptual architectures 200A, 200B illustrated in FIGS. 2A and 2B, respectively, include a development system 102, a testing system 202, a deployment system 104, an error control system 116 and a difference checker system 118. The error control system 116 can include an error database 204, an error correction system 206, and an error management system 208.

The error control system 116 can be implemented in or coupled to a server system (e.g., first and second server systems 110, 112 described with reference to FIG. 1) of a development system (e.g., development system 102), a testing system 202, or a deployment system (e.g., deployment system 104). The server system can be configured to monitor and/or manage a deployment process of an instance of a software application. The error control system 116 can manage a plurality of tracking objects that can be integrated in or connected to a computing device (e.g., one of the computing devices 114A, 114B, 114C where a (portion of) software product is deployed. For example, the error control system 116 can manage a deployment iteration object that interacts with the product specification object at the error control system 116. The deployment tracker can also manage a task log object, which can interact with a feature object at the error control system 116. Furthermore, the task log object can include a plurality of task objects. Each task object can correspond to a deployment task scheduled to be completed. For example, a first task object instance corresponding to a first time point can define a deployment task scheduled to be completed at a particular computing device, in order to effect the change associated with a corresponding change object of the software product. A second task object instance corresponding to a second time point can define a task scheduled to be completed in order to realize the change associated with a second change object different from the first task object. Alternatively and/or additionally, a third task object instance corresponding to a third time point can correspond to a task scheduled to be completed in order to realize the change associated with a third change object. The first task object, the second task object, and the third task object can interact in parallel or sequentially, respectively, with the first change object, the second change object, and the third change object at the particular computing device to complete a deployment of the software product. If the error control system 116 determines that an error has occurred in connection with a deployment request, the error control system 116 writes an error message as error log 210 in a file and stores the error log 210 in an error database 204 and also transmits the error log 210 to the difference checker system 118. The error message identifies the particular error that occurred. The error log 210, formatted as a file, can include information related to software application errors identifying a portion of the software product (object instance) that generated the error in a particular computing device (e.g., computing devices 114A, 114B, 114C) managed by the server system. The information collected in the error log 210 can include system log files corresponding to processes executed by computing devices (identified according to system configurations), as well as information generated by server systems of the deployment system managing the deployment process.

The difference checker system 118 can be configured to process the error log 210 to identify differences between object instances associated with the detected error included in the error log received from the error control system 116. The difference checker system 118 can include a version retriever module 212 and an error analysis module 214. In some implementations, the difference checker system 118 can be configured to enable an automatic activation of the version retriever module 212 to retrieve and access different versions of a software application 216A, 216B to extract corresponding software production specifications, ACL instances and object instances A, B 218A, 218B. The different versions of a software application 216A, 216B can include an older (reference) version of the software application 216A that can be a verified error free software product and a current version of the software application 216B that can be associated with the error, such as, a software update or a software customization. After the object instances A, B 218A, 218B corresponding to different versions of the software application 216A, 216B are determined and stored in an object instance database 222, the error analysis module 214 can perform operations to automatically identify differences between the versions of the software application 216A, 216B based on object instance changes and ACL modifications. After the difference identification is completed, the difference checker system 118 can transmit the object instance changes and/or ACL modifications associated with the identified error to the error correction system 206 of the error control system 116.

The error correction system 206 can process the software application errors, using the identified instance changes, to automatically determine a pattern of the software application error. The error correction system 206 can retrieve past software application errors from the error database 204. The error correction system 206 can search though past software application errors, to identify a match between the current software application error included in the deployment log and a past software application error based on the pattern of the software application instance changes. In some implementations, the software application error patterns are being analyzed using a model. The model can include one or more machine learning models trainable to generate the software application error pattern matches. The one or more machine learning models can be trained, recalibrated, and updated to generate software application error pattern matches with increased accuracy even for computing systems with variable components. The software application error pattern matches can be used to correct software application errors with repeated patterns, while new patterns are used for retraining the model. The provided solution can include a machine learning model that can be applied to most types of computing device configurations and software product configurations. If the current software application error associated with an identified instance change matches a past software application error associated with a similar instance change, the error correction system 206 can retrieve from the error database 204 a solution associated with the matching past software application error. The error correction system 206 can automatically transmit the solution for the current software application error to the error management system 208.

The management system 208 can transmit the solution for the current software application error to a system configured to implement the solution to the current instance of the software application, such as the development system 102, the testing system 202, or the deployment system 104. In some implementations, the error control system 116 can be configured to automate the deployment of the software update corresponding to the product specification object. For example, the error control system 116 can include a deployment engine configured to perform sequential or parallel deployment of each change that is made in order to implement the solution for the current software application error as features of the software update in one or more computing devices, such as the computing devices 114A, 114B, 114C, as illustrated in FIG. 2B.

If the implementation of the solution leads to successful deployment of the software product, the solution is transmitted, by the management system 208, to be stored in the error database 204. In some example implementations, where the error control system 116 determines that the corresponding change of a proposed solution did not successfully deploy the software product, the error control system 116 can generate an updated deployment log that adds the corresponding error associated with the failed solution. The error control system 116 can communicate with the difference checker system 118 to initiate an iterative implementation of an updated solution to address the current software application error until the software product is successfully deployed on the computing device. After the iterative solution is successfully implemented, leading to successful deployment of the software product, the iterative solution can be transmitted, by the management system 208, to be stored in the error database 204, becoming accessible for future error pattern matches.

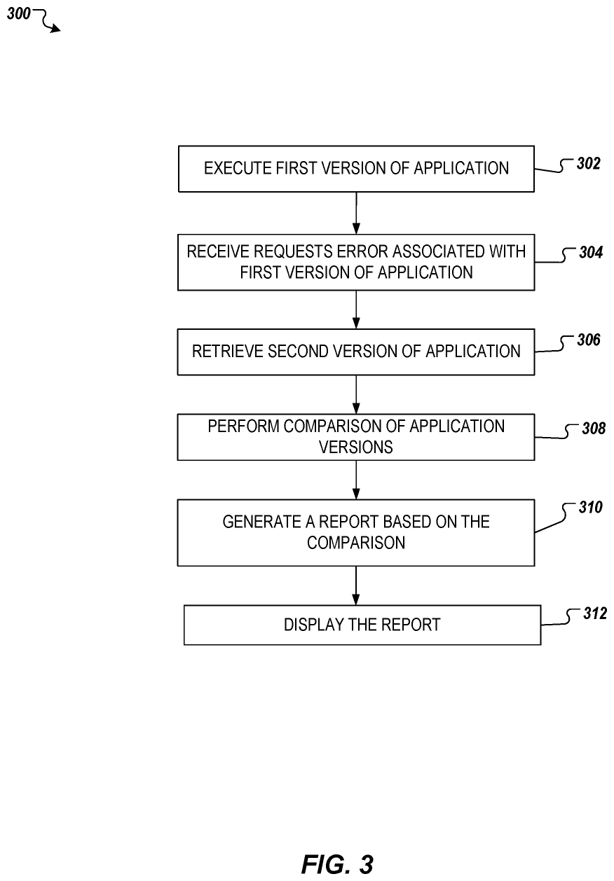

FIG. 3 depicts a flowchart illustrating an example of a process 300 for automatically addressing software application errors, in accordance with some example implementations. The process 300 can be performed by first and second server systems 110, 112 described with reference to FIG. 1 or one or more components (e.g., the error correction system 206) of the error control system 116 described with reference to FIGS. 2A and 2B.

At 302, a first (current) version of a software application is executed. For example, the first version of a software product is deployed at a computing system including one or more computing devices having a particular configuration, such as particular operating systems, particular processing capabilities, particular hardware components, particular user controls and/or particular user access levels. The first version of the cloud-based software application can include one or more customizations specific to a cloud-based computing system. The software product can include a software update of a second (older) version of a software already installed in the computing device or a customization of a second (standard or basic) version of the software. The software product can include a software product configuration including multiple software product features. At least a portion of the software product features can be associated with one or more computing device configuration requirements (e.g., minimum processing resources, data storage capacity, RAM, etc. that are needed to execute the computer-executable code with a particular a software product configuration). For example, the software product configuration can include a feature defining a minimum capability of the computing device to enable installation and/or execution of a function included in the software product on the computing device. In some implementations, the software configuration can include a class definition identifying a connection between software product modules according to class hierarchies, class parameters used to configure a computing device for the deployment of the software product to customize the computing device hosting deployment, and function requirements defining minimum processing capabilities of the computing device configuration for deployment and execution of the software product. In some implementations, the computing device configuration can include computing module (platform) definitions that facilitate the deployment of new or update software products. Each computing platform definition is associated with an individual computing module, describing the processing capabilities of the computing module and the access level required for a user to initiate deployment of the software product. Each segmented computing module can be uniquely identifiable via a unique identifier such as, e.g., a unique addressable namespace. Segmenting computing platforms also allows for efficient evaluation of the performance of a computing platform to identify necessary modifications for deployment of the software product with a particular software configuration.

At 304, an error log (report) is received. The error log can be a text readable file including a deployment log. The error log can include one or more software application errors generated by an execution engine tracking the deployment of the software product throughout a computing system including multiple computing devices with fixed and/or variable components. In some implementations, the error log includes multiple software application errors that are related to each other, which can a complex deployment failure. Each of the software application errors included in the error log can be individually extracted to be separately processed, such that each symptom associated with a software application error is separately processed. The error log can include expressions that describe the symptoms associated with the software application errors and software application error identifiers. The software application error identifiers can include a software identifier and a device identifier. The software identifier can identify an object (a component) of the software product that failed to be deployed. The software product can include multiple objects. Each software object can depend on one or more services. The device identifier can identify a first (current) object instance associated with the error (e.g., the component of the software product that failed to be deployed at a particular computing device with a particular configuration). The first object instance can correspond to a first (current) version of the software product that failed to be deployed.

At 306, at least a portion of a second (a most recent older error free) version of the software product that failed to be deployed is retrieved from a database. A portion of the second version of the software product can include a second (a most recent older error free) object instance that is an older version of the first (current) object instance associated with the error.

At 308, a comparison of the application versions is performed. The comparison can include an analysis of object instances, attribute instances including the source, the binary code, and a map file of a software update with its corresponding object instances, attribute instances of the first (current) software. The attributes can be retrieved from a database of a production toolchain (e.g., as part of, or following, the software build and deploy processes). The source attribute may identify, for example, the source code language, version, whether the source code is flat, the number and/or type of objects referenced in the source code, and other attributes. The binary attribute may be represented as Executable and Linkable Format (ELF) code (e.g., with program header, section header, data, etc.), as pure binary, or in other forms. The map file may describe relationships and dependencies between functions and entities in the software product, the size of the software product, particular memory addresses, particular functions or commands corresponding to memory locations, etc. The comparison can include a representation of software instances, as updated software product and current software product in terms of their source, binary code, and map file attributes may be referred to as a “grid” representation, and a comparison between a grid representing software update and a grid representing current software may be referred to as a multi-dimensional (e.g., three-dimensional differential comparison) In some implementations, fewer or additional dimensions may be used as well. The multi-dimensional comparison, may be utilized to generate comparison results (e.g., a delta file) that may include data representing changes made to the binary and/or the source code, changes made to one or more variables used by a computing system, and changes made to memory addresses referenced by the computing system.

At 310, a report that is representative of the results of the comparison of the application versions, as performed in 308, can be generated. In some implementations, such a report may be an interactive digital report that is generated by the first and second server systems 110 and 112, operating individually or in conjunction. This interactive digital report can include a listing of the results of the comparison of the first version of the software product and the second version of the software product. The listing of the results includes one or more differences between the first and second software product versions. These differences can relate to object instances, attribute instances, binary code, map files of software updates corresponding to object instances, and so forth. In some embodiments, these differences can be ranked according to various criteria, e.g., computing resource use.

At 312, the report that was generated at 310 can be displayed on the user interface 122 of the user device 108 and/or on the respective user interfaces of the computing devices 114A, 114B, 114C. In some embodiments, the report can be an interactive digital report that is viewed and analyzed by a programmer. The analysis may enable the determination of the source of an error (e.g., one or more portions of the software application) that caused or resulted in a failure of the deployment of the software product at a particular computing device, e.g., at a particular point in time. In some implementations, data related to the operation of the computing system during the identified error can be retrieved and processed to increase the accuracy of the error source identification.

Alternatively, in embodiments, subsequent to the performing of a comparison of the first and second software product versions at 308, a solution for resolving one or more software application errors can be automatically identified, e.g., by the error correction system 206. In particular, the solution can be identified with the use of an error correction model, such as a machine learning model that is configured to process errors associated with software product instance differences. In some embodiments, the machine learning model is implemented using a machine learning module 220 included as part of the error correction system 206. For example, the software application error can be automatically processed to determine a pattern of the one or more software application errors. The symptoms associated with the software application errors, the software configuration, and the computing device configuration can be processed to determine the pattern of the corresponding software application error. The pattern can be associated with a system feature including one or more parameters of the device configuration and/or the pattern can be associated with a feature of the software product including one or more parameters of the software configuration.

The software application error pattern matches can be identified using a software application error pattern processing model. The software application error pattern processing model can include one or more machine learning models trainable to identify software application error pattern matches. The one or more machine learning models can be trained, recalibrated, and updated to be trained to identify software application error pattern matches. In some implementations, a single software application error pattern match can be selected to avoid overlapping patterns that could lead to potential errors in solution selection. In some implementations, the error correction model can generate as output multiple solutions that can be ranked relative to data processing efficiency, memory usage requirements, speed of implementation, and downtime of computing system.

The top ranked solution can be compared to one or more thresholds defining acceptable change ranges to prevent expensive, time-consuming, and disruptive processes that can be associated with solutions that are outside the set ranges. If the top ranked solution fails to satisfy at least one condition (a solution parameter is outside a range), the top ranked solution can be replaced by a backup solution including rolling back the first software version to the second (prior) version without the need to download an entire software module, without reprogramming the memory, and without significant memory requirements or any downtime of the computing system.

In some embodiments, an identified solution can be provided for the purpose of correcting an error. For example, the providing the solution can include implementing a modification of a feature of the software product based on the matching pattern and deploying the software product with the updated feature to the computing device to complete deployment. For example, correcting the error can include a modification of an object of the cloud-based software application. The modified object can include an access control list dependent object (ACL DO) including an access control list, the access control list being used as part of an access control check to confirm whether a customer (e.g., tenant) is allowed to execute the requested operation.

The access control check can include a verification of an object type corresponding to the object specified and of on an access group associated with the tenant. The access control list can specify which nodes of the object are subject to instance control, the access control list further specifying which access groups can perform operations on each node of an object instance. The access control list further can specify operations enabled to be performed on each node of the object instance by particular access groups. The access control list further can specify temporal access limitations for one or more nodes of the object instance. The access control list dependent object can be accessed via an access path within the object that is specified by the object. Computing platforms of a computing device can be segmented to enable efficient deployment of the software product with a particular software configuration.

The solutions for software application error patterns that repeatedly occur a number of times within a particular time interval can be automatically implemented to correct software application errors with matching patterns. The machine learning model can learn associations between software application error patterns and solutions (e.g., actions taken during deployment of a software component at a computing device and whether a solution to correct a software application error with a particular pattern matching a current software application error pattern was successful or failed). The machine learning model can use supervised learning, unsupervised learning, deep learning, or other machine learning techniques for pattern matching and solution selection.

In some embodiments, an updated version of the software application can be tested. For example, the machine learning model described above can include a recommendation system that uses the results of the machine learning model to recommend one or more actions for an execution engine to automatically correct the software application errors expected to most likely lead to a successful deployment and to reduce a time to deployment in a production release. In some implementations, in response to deploying the software product with the updated feature to the computing device, an outcome of the successful completion of the deployment can be generated or the process 300 can return to receiving an updated error log. A record associated with a successful correction of the software application error (leading to successful completion of the updated software deployment) can be generated and transmitted for storage in a software application error database.

The record can include an automatic report with an overview of all software application errors occurred in particular time period. The record can be available for the management and developers. The record can include the names of the issues, links to the tickets, links to the error logs of all occurrences of a particular software application error, regular expressions used to detect the respective software application errors and a number of software application error occurrences within a particular time period (e.g., last 3-9 months or last 1-3 years).

In some embodiments, the service previously interrupted by the error occurrence can be automatically triggered to be executed on the computing system and another report can be generated and displayed. For example, the report can include a result of the service execution that is displayed on the computing system. In some embodiments, the report can also include an alert indicating the error occurrence and error records that is displayed on an administrator's computing system.

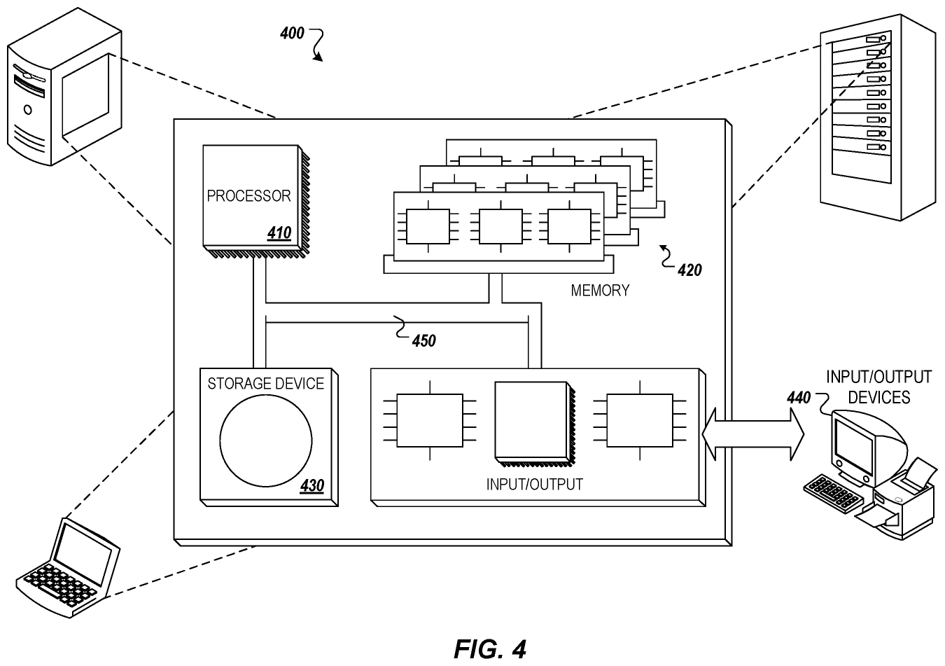

Referring now to FIG. 4, a schematic diagram of an example computing system 400 is provided. The example computing system 400 can be used for automatically addressing software application errors, as described in association with the implementations described herein. For example, the example computing system 400 can be included in any or all of the server components discussed herein with reference to FIGS. 1 and 2. The example computing system 400 includes a processor 410, a memory 420, a storage device 430, and an input/output device 440. The components 410, 420, 430, 440 are interconnected using a system bus 450. The processor 410 is capable of processing instructions for execution within the example computing system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the example computing system 400. In one implementation, the memory 420 is a computer-readable medium. In one implementation, the memory 420 is a volatile memory unit. In another implementation, the memory 420 is a non-volatile memory unit. The storage device 430 is capable of providing mass storage for the example computing system 400. In one implementation, the storage device 430 is a computer-readable medium. In various different implementations, the storage device 430 can be a floppy disk device, a hard disk device, an optical disk device, or a tape device. The input/output device 440 provides input/output operations for the example computing system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other implementations are within the scope of the following claims.

A number of implementations of the present disclosure have been described. Nevertheless, it will be understood that various modifications can be made without departing from the spirit and scope of the present disclosure. Accordingly, other implementations are within the scope of the following claims.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” can occur followed by a conjunctive list of elements or features. The term “and/or” can also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Further non-limiting aspects or embodiments are set forth in the following numbered clauses:
Clause 1: A computer-implemented method, comprising: receiving, by one or more processors, data of an error included in a first version of a cloud-based software application hosted by a cloud-based computing system, the first version of the cloud-based software application corresponding to a first instance of a version of the cloud-based software application; retrieving, by the one or more processors, a second version of the cloud-based software application hosted by the cloud-based computing system, the second version of the cloud-based software application corresponding to a second instance of the version of the cloud-based software application; comparing, by the one or more processors, the first version of the cloud-based software application to the second version of the cloud-based software application; generating based on the comparing, by the one or more processors, a result comprising differences between the first version of the cloud-based software application and the second version of the cloud-based software application; and outputting the result on a display that is communicatively coupled to the one or more processors.
Clause 2: The computer-implemented method of clause 1, further comprising enabling, by the one or more processors, a correction of the error based on the result comprising the differences between the first version of the cloud-based software application and the second version of the cloud-based software application.
Clause 3: The computer-implemented method of clause 2, further comprising: ranking a plurality of solutions to correct the error; determining that parameters of a first solution of the plurality of solutions are below a threshold; and automatically implementing the first solution of the plurality of solutions to correct the error.
Clause 4: The computer-implemented method of clause 2, wherein the correction of the error comprises a modification of an object of the cloud-based software application.
Clause 5: The computer-implemented method of clause 4, wherein the object comprises an access control list dependent object (ACL DO) comprising an access control list, the access control list being used as part of an access control check to confirm whether a tenant is allowed to execute an operation.
Clause 6: The computer-implemented method of clause 5, wherein the access control list dependent object is accessed via an access path within the object that is specified by the object.
Clause 7: The computer-implemented method of clause 5, wherein the access control check comprises a verification of an object type corresponding to the object specified and of on an access group.
Clause 8: The computer-implemented method of clause 7, wherein the access control list specifies which nodes of the object are subject to instance control, the access control list further specifying which access groups can perform operations on each node of an object instance.
Clause 9: The computer-implemented method of clause 8, wherein the access control list further specifies operations enabled to be performed on each of the nodes of the object instance by particular access groups.
Clause 10: The computer-implemented method of clause 9, wherein the access control list specifies temporal access limitations for one or more nodes of the object instance.
Clause 11: The computer-implemented method of clause 1, wherein the first version of the cloud-based software application comprises one or more customizations associated with the cloud-based computing system.
Clause 12: The computer-implemented method of clause 1, wherein the data of the error is included as part of a digital error log.
Clause 13: The computer-implemented method of clause 11, wherein the error is associated with a software identifier and a device identifier.
Clause 14: The computer-implemented method of clause 13, wherein the software identifier is representative of an object of the first version of the cloud-based software application that failed to deploy and the device identifier is representative of an object instance associated with the error.
Clause 15: A system comprising: at least one data processor; and
at least one memory storing instructions, which when executed by the at least one data processor, cause operations comprising: receiving, by the at least one data processor, data of an error included in a first version of a cloud-based software application hosted by a cloud-based computing system, the first version of the cloud-based software application corresponding to a first instance of a version of the cloud-based software application; retrieving, by the at least one data processor, a second version of the cloud-based software application hosted by the cloud-based computing system, the second version of the cloud-based software application corresponding to a second instance of the version of the cloud-based software application; comparing, by the at least one processor, the first version of the cloud-based software application to the second version of the cloud-based software application; and generating based on the comparing, by the at least one data processor, a result comprising differences between the first version of the cloud-based software application and the second version of the cloud-based software application; and outputting the result on a display that is communicatively coupled to the one or more processors.
Clause 16: The system of clause 15, wherein the operations further comprise enabling, by the at least one data processor, a correction of the error based on the result comprising the differences between the first version of the cloud-based software application and the second version of the cloud-based software application.
Clause 17: The system of clause 16, wherein the operations further comprise: ranking a plurality of solutions to correct the error; determining that parameters of a first solution of the plurality of solutions are below a threshold; and automatically implementing the first solution of the plurality of solutions to correct the error.
Clause 18: The system of clause 16, wherein: the correction of the error comprises a modification of an object of the cloud-based software application; the first version of the cloud-based software application comprises one or more customizations associated with the cloud-based computing system; the data of the error is included as part of a digital error log; and the error is associated with a software identifier and a device identifier, the software identifier is representative of an object of the first version of the cloud-based software application that failed to deploy and the device identifier is representative of an object instance associated with the error.
Clause 19: The system of clause 16, wherein: the object of the cloud-based software application comprises an access control list dependent object (ACL DO) comprising an access control list, the access control list being used as part of an access control check to confirm whether a tenant is allowed to execute an operation, the access control list dependent object is accessed via an access path within the object that is specified by the object; the access control check comprises a verification of an object type corresponding to the object specified and of on an access group; the access control list specifies which nodes of the object specified and of on the access group are subject to instance control, the access control list further specifying which access groups can perform operations on each node of an object instance; the access control list further specifies operations enabled to be performed on each of the nodes of the object instance by particular access groups; and the access control list specifies temporal access limitations for one or more nodes of the object instance.
Clause 20: A non-transitory computer-readable storage media comprising programming code, which when executed by at least one data processor, causes operations comprising: receiving data of an error included in a first version of a cloud-based software application hosted by a cloud-based computing system, the first version of the cloud-based software application corresponding to a first instance of a version of the cloud-based software application; retrieving a second version of the cloud-based software application hosted by the cloud-based computing system, the second version of the cloud-based software application corresponding to a second instance of the version of the cloud-based software application; comparing the first version of the cloud-based software application to the second version of the cloud-based software application; generating, based on the comparing, by the at least one data processor, a result comprising differences between the first version of the cloud-based software application and the second version of the cloud-based software application; and outputting the result on a display that is communicatively coupled to the at least one data processor.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed is:

1. A computer-implemented method comprising:
receiving, by one or more processors, data of an error included in a first version of a cloud-based software application hosted by a cloud-based computing system, the first version of the cloud-based software application corresponding to a first instance of a version of the cloud-based software application;
retrieving, by the one or more processors, a second version of the cloud-based software application hosted by the cloud-based computing system, the second version of the cloud-based software application corresponding to a second instance of the version of the cloud-based software application;
comparing, by the one or more processors, the first version of the cloud-based software application to the second version of the cloud-based software application;
generating based on the comparing, by the one or more processors, a result comprising differences between the first version of the cloud-based software application and the second version of the cloud-based software application; and
outputting the result on a display that is communicatively coupled to the one or more processors.

2. The computer-implemented method of claim 1, further comprising enabling, by the one or more processors, a correction of the error based on the result comprising the differences between the first version of the cloud-based software application and the second version of the cloud-based software application.

3. The computer-implemented method of claim 2, further comprising:
ranking a plurality of solutions to correct the error;
determining that parameters of a first solution of the plurality of solutions are below a threshold; and
automatically implementing the first solution of the plurality of solutions to correct the error.

4. The computer-implemented method of claim 2, wherein the correction of the error comprises a modification of an object of the cloud-based software application.

5. The computer-implemented method of claim 4, wherein the object comprises an access control list dependent object comprising an access control list, the access control list being used as part of an access control check to confirm whether a tenant is allowed to execute an operation.

6. The computer-implemented method of claim 5, wherein the access control list dependent object is accessed via an access path within the object that is specified by the object.

7. The computer-implemented method of claim 5, wherein the access control check comprises a verification of an object type corresponding to the object specified and of on an access group.

8. The computer-implemented method of claim 7, wherein the access control list specifies which nodes of the object are subject to instance control, the access control list further specifying which access groups can perform operations on each node of an object instance.

9. The computer-implemented method of claim 8, wherein the access control list further specifies operations enabled to be performed on each of the nodes of the object instance by particular access groups.

10. The computer-implemented method of claim 9, wherein the access control list specifies temporal access limitations for one or more nodes of the object instance.

11. The computer-implemented method of claim 1, wherein the first version of the cloud-based software application comprises one or more customizations associated with the cloud-based computing system.

12. The computer-implemented method of claim 1, wherein the data of the error is included as part of a digital error log.

13. The computer-implemented method of claim 11, wherein the error is associated with a software identifier and a device identifier.

14. The computer-implemented method of claim 13, wherein the software identifier is representative of an object of the first version of the cloud-based software application that failed to deploy and the device identifier is representative of an object instance associated with the error.

15. A system comprising:
at least one data processor; and
at least one memory storing instructions, which when executed by the at least one data processor, cause operations comprising:
receiving, by the at least one data processor, data of an error included in a first version of a cloud-based software application hosted by a cloud-based computing system, the first version of the cloud-based software application corresponding to a first instance of a version of the cloud-based software application;
retrieving, by the at least one data processor, a second version of the cloud-based software application hosted by the cloud-based computing system, the second version of the cloud-based software application corresponding to a second instance of the version of the cloud-based software application;
comparing, by the at least one processor, the first version of the cloud-based software application to the second version of the cloud-based software application; and
generating based on the comparing, by the at least one data processor, a result comprising differences between the first version of the cloud-based software application and the second version of the cloud-based software application; and
outputting the result on a display that is communicatively coupled to the at least one data processor.

16. The system of claim 15, wherein the operations further comprise enabling, by the at least one data processor, a correction of the error based on the result comprising the differences between the first version of the cloud-based software application and the second version of the cloud-based software application.

17. The system of claim 16, wherein the operations further comprise:
ranking a plurality of solutions to correct the error;
determining that parameters of a first solution of the plurality of solutions are below a threshold; and
automatically implementing the first solution of the plurality of solutions to correct the error.

18. The system of claim 16, wherein:
the correction of the error comprises a modification of an object of the cloud-based software application;
the first version of the cloud-based software application comprises one or more customizations associated with the cloud-based computing system;
the data of the error is included as part of a digital error log; and
the error is associated with a software identifier and a device identifier, the software identifier is representative of an object of the first version of the cloud-based software application that failed to deploy and the device identifier is representative of an object instance associated with the error.

19. The system of claim 16, wherein:
the object of the cloud-based software application comprises an access control list dependent object comprising an access control list, the access control list being used as part of an access control check to confirm whether a tenant is allowed to execute an operation, the access control list dependent object is accessed via an access path within the object that is specified by the object;
the access control check comprises a verification of an object type corresponding to the object specified and of on an access group;
the access control list specifies which nodes of the object specified and of on the access group are subject to instance control, the access control list further specifying which access groups can perform operations on each node of an object instance;
the access control list further specifies operations enabled to be performed on each of the nodes of the object instance by particular access groups; and
the access control list specifies temporal access limitations for one or more nodes of the object instance.

20. A non-transitory computer-readable storage media comprising programming code, which when executed by at least one data processor, causes operations comprising:
receiving data of an error included in a first version of a cloud-based software application hosted by a cloud-based computing system, the first version of the cloud-based software application corresponding to a first instance of a version of the cloud-based software application;
retrieving a second version of the cloud-based software application hosted by the cloud-based computing system, the second version of the cloud-based software application corresponding to a second instance of the version of the cloud-based software application;
comparing the first version of the cloud-based software application to the second version of the cloud-based software application;
generating, based on the comparing, by the at least one data processor, a result comprising differences between the first version of the cloud-based software application and the second version of the cloud-based software application; and
outputting the result on a display that is communicatively coupled to the at least one data processor.
